(19) United States
(12) Patent Application Publication
(10) Pub. No.: US 2005/0019679 A1
(43) Pub. Date: Jan. 27, 2005

(54) [COLOR FILTER SUBSTRATE AND FABRICATING METHOD THEREOF]

(76) Inventors: Wen-Chin Lo, MIAOLI COUNTY (TW); Chien-Hsing Li, TAICHUNG CITY (TW); Liang-Jen Lin, TAICHUNG COUNTY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,784

(22) Filed: Mar. 25, 2004

(30) Foreign Application Priority Data
Jul. 22, 2003 (TW) 92119939

(51) Int. Cl. G02B 5/20; G02F 1/1335

(52) U.S. Cl. 430/7

(57) ABSTRACT

A method of fabricating a color filter substrate is described. A black matrix is formed on a substrate. A color photoresist is formed for covering the black matrix. A photomask is located over the substrate, and then an exposure process is performed. The photomask comprises a transparent region, a partial transparent region and a no-transparent region, wherein the partial transparent region is located between the transparent region and the no-transparent region and is also located at the edge of the black matrix. A development process is performed for patterning the color photoresist. Since the exposure process is performed with the photomask via the partial transparent region, the issue that the height difference exists at the edge of the black matrix due to using black resin can be resolved.

### CROSS REFERENCE TO RELATED APPLICATIONS

This application claims the priority benefit of Taiwan application serial no. 92119939, filed on Jul. 22, 2003.

### BACKGROUND OF INVENTION

1. Field of the Invention

The present invention relates to a method of fabricating a color filter substrate and a structure formed thereby, and more particularly, to a method of fabricating a color filter substrate by using black resin as a material of a black matrix and a structure formed thereby.

2. Description of the Related Art

Since technologies have advanced, video products, especially digital video products and image-display devices have become common products within our daily life. In theses digital video products, displays are a very important device for displaying information and images. Users can read information via displays, or control the operation of devices via displays.

For adapting the feature of being portable, sizes of these video products have become smaller. Although traditional cathode ray tube (CRT) displays have some advantages, they have big size and are of higher power consumption. Therefore, through the development of optical-electrical and semiconductor manufacturing technologies, planar displays have been developed and become a commonly used display, such as a liquid crystal display. Because liquid crystal displays have low operational power consumptions, non-radiant emissions, less weights and small sizes, which cannot be provided by displays fabricated by traditional cathode ray tube process. Eversince, research and development of liquid crystal displays and the other planar displays, such as plasma displays and electroluminance displays have become a main subject and they are deemed to be the dominant displays in the twenty-first century.

For example, in a thin film transistor (TFT) display, a liquid crystal substrate is composed of a thin film transistor array substrate, a color filter array substrate and a liquid crystal layer. The liquid crystal layer is formed between the color filter array substrate and the thin film transistor array substrate, wherein the color filter array substrate is formed, for example, by the steps of: forming a black matrix on a color photoresist layer, and then forming a protection layer, an electrode layer or the other material layer.

Usually, the material of the black matrix is Cr, which has a thickness about 0.2 μm. After a color photoresist layer is formed on the substrate, a step height arises at the interface between the black matrix and the color photoresist layer, i.e. at the edge of the black matrix. As shown in FIG. 1, a color photoresist layer (not shown) is comprehensively formed on the substrate 100 after the black matrix 102 is formed thereon, then a photolithographic process is performed for patterning the color photoresist layer 104. Because the color photoresist layer (not shown) is comprehensively formed on the substrate 100 by a spin coating process, a step height hi which is about 0.2 μm exists at the interface between the black matrix 102 and the color photoresist layer 104. The step height hi does not affect displaying performance of displays.

Although the small step height does not affect displaying performance of displays, however, Cr serving as the material of the black matrix will create environmental pollution problems. In view of environmental pollution problems, black resin is replaced by Cr and is used as the material of the black matrix. Even though the replacement of the material of the black matrix by black resin can resolve environmental pollution problems, but a step height h2, which is about 0.5˜0.8 μm exists at the edge of the black matrix as shown in FIG. 2 as the black resin layer formed by a spin coating process has a thickness higher than that of the Cr layer by about 1.0˜1.2 μm. The step height h2 will affect light diffraction within liquid crystal. Moreover, color photoresist layers having different colors, such as red, green, and blue, will generate different step heights h2, and create displaying performance issue of displays.

Although the step height issue can be resolved by a polish process, an additional polish process step is required that will result in lower through-put and therefore is not a total solution for the issues mentioned above.

### SUMMARY OF INVENTION

Accordingly, the object of the present invention provides a method of fabricating a color filter substrate and a structure formed thereby in order to resolve step height issue at an edge of a black matrix resulting from using black resin as the material of the black matrix.

The present invention discloses a method of fabricating a color filter substrate. The method includes forming a black matrix on a substrate, wherein the material of the black matrix is, for example, black resin. A color photoresist layer is then formed on the substrate covering the black matrix. A photomask is then set above the substrate and an exposure process is performed on the photoresist layer, wherein the photomask has a transparent region, a partial transparent region and a non-transparent region, and wherein the partial transparent region is located between the transparent region and the non-transparent region and aligned to the edge of the black matrix correspondingly. Finally, a development process is performed for patterning the color photoresist layer. What is notable is that a transparency of the partial transparent region is, for example, gradually reduced from the transparent region to the non-transparent region.

The present invention provides another method of fabricating a color filter substrate. The method includes forming a black matrix on a substrate, wherein the black matrix has a first region, a second region and a third region. Then a first color photoresist layer is formed on the substrate covering the black matrix. A first photomask is then set above the substrate and a first exposure process is performed for the first photoresist layer, wherein the first photomask has a first transparent region, a first partial transparent region and a first non-transparent region, and the first partial transparent region is located between the first transparent region and the first non-transparent region and aligned to the edge of the black matrix correspondingly. Then a second color photoresist layer is then formed on the substrate and covers the black matrix. A second photomask is then set above the substrate and a second exposure process is performed for the second photoresist layer, wherein the second photomask has a second transparent region, a second partial transparent region and a second non-transparent region, and the second partial transparent region is located between the second transparent region and the second non-transparent region and aligned to the edge of the black matrix correspondingly. Then a third color photoresist layer is then formed on the substrate and covers the black matrix. A third photomask is then set above the substrate and a third exposure process is performed for the third photoresist layer, wherein the third photomask has a third transparent region, a third partial transparent region and a third non-transparent region, and the third partial transparent region is located between the third transparent region and the third non-transparent region and aligned to the edge of the black matrix correspondingly. The transparent area of the first partial transparent region of the first photomask is gradually reduced from the first transparent region to the first non-transparent region, the transparent area of the second partial transparent region of the second photomask is gradually reduced from the second transparent region to the second non-transparent region, and the transparent area of the third partial transparent region of the third photomask is gradually reduced from the third transparent region to the third non-transparent region.

Because the present invention uses a mask having a partial transparent region for performing an exposure process, a photoresist region is formed after the exposure process is performed. The removal rate of the photoresist region formed by the partial transparent region is between those of the photoresist regions formed by a transparent region and by a non-transparent region. Therefore, the present invention can resolve the step height issue at an edge of a black matrix and form a photoresist layer having a planar surface.

The present invention discloses a structure of color filter substrate. The structure comprises a substrate, a black matrix and a photoresist layer, wherein the black matrix is formed on the substrate and the material of the black matrix is, for example, black resin. In addition, the photoresist layer is formed on the substrate, a portion of the photoresist layer covers the edge of the black matrix, and the photoresist layer has a planar surface.

Because the photoresist layer formed on the substrate has a planar surface, liquid crystal displays with the color filter substrates formed by the present invention does not have the displaying problems of liquid crystal displays formed by the prior arts.

### BRIEF DESCRIPTION OF DRAWINGS

FIG. 1 illustrates a schematic cross sectional view of a color filter substrate in accordance with the prior art.

FIG. 2 illustrates a schematic cross sectional view of another color filter substrate in accordance with the prior art.

FIGS. 3A to 3D are schematic cross sectional views showing the progression of process steps of a process of fabricating a color filter substrate according to a preferred embodiment of the present invention.

FIG. 4 is a schematic top view of the partial transparent region of the photomask shown in FIG. 3C.

FIGS. 5A to 5J are schematic cross sectional views showing the progression of process steps of a process fabricating a full-color filter substrate according to a preferred embodiment of the present invention.

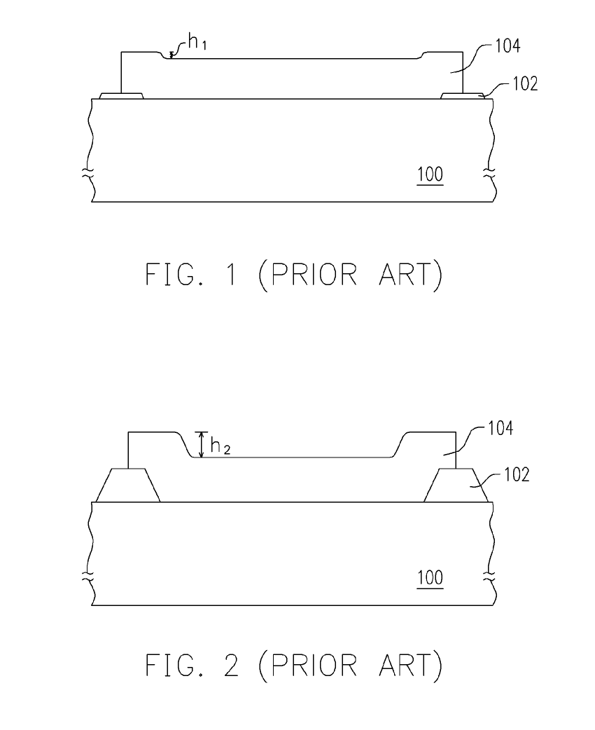

### DETAILED DESCRIPTION

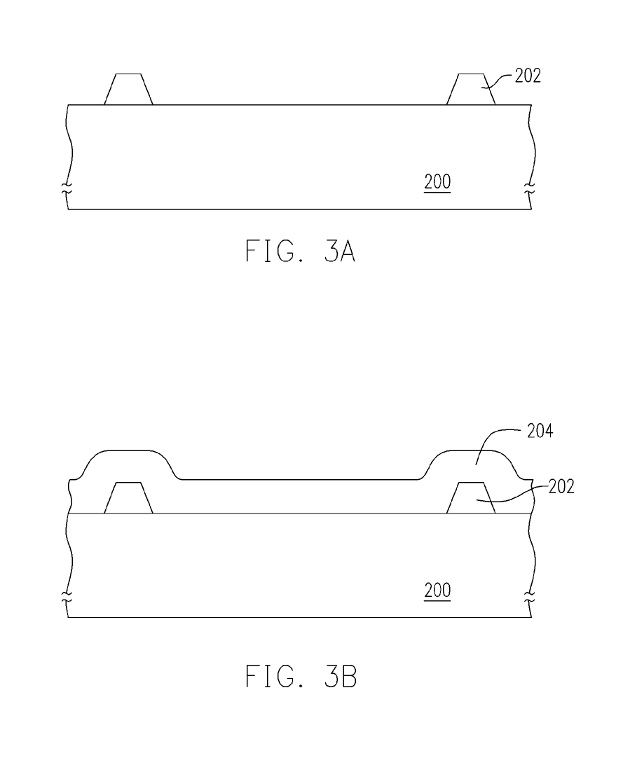

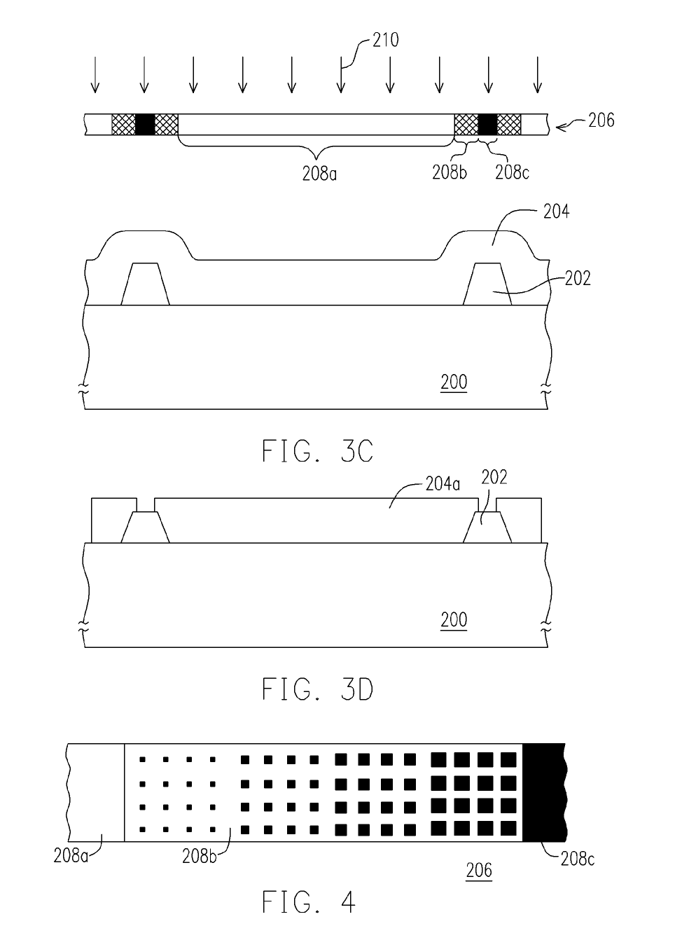

FIGS. 3A to 3D are schematic cross sectional views showing the progression of process steps of a process of fabricating a color filter substrate according to a preferred embodiment of the present invention.

Referring to FIG. 3A, the method of fabricating a color filter substrate begins with a comprehensive formation of a non-transparent material (not shown) on a substrate 200. The material of the non-transparent material is, for example, a black resin having a thickness of about 1.0 μm to about 1.2 μm. A traditional photolithographic process is performed on the non-transparent material for patterning a black matrix 202.

Then, referring to FIG. 3B, a color photoresist layer 204 is formed on the substrate 200 for covering the black matrix 202, wherein the color of the color pohotresist layer 204 can be, for example, red, green or blue. The color photoresist layer 204 can be formed, for example, by a spin coating process and a baking process. In addition, the color photoresist layer 204 can be a negative photoresist which has an enhanced bonding strength after being processed from a subsequent exposure process, or a positive photoresist which has a reduced bonding strength after being processed from a subsequent exposure process. In this embodiment, the color photoresist layer 204 is a negative photoresist.

In addition, it is to be noted is that because the thick black matrix 202 is formed on the substrate 200, a step height of the color photoresist layer 204 on the black matrix 202 exists and a non-planar color photoresist layer 204 is formed thereon.

Then, referring to FIG. 3C, a photomask 206 is set above the substrate 200 for performing an exposure process 210 on the color photoresist layer 204, wherein the photomask is composed by a glass and a non-transparent film and has transparent and non-transparent regions defined based on different design requirements. Moreover, the non-transparent film is located on the non-transparent regions, and a conventional material of the non-transparent film is, for example, Cr. In addition, the exposure process 210 is performed, for example, by using a UV light source.

It is to be noted is that in addition to a transparent region 208a and a non-transparent region 208c, the photomask 206 further comprises a partial transparent region 208b located between the transparent region 208a and the non-transparent region 208c, and aligned to the edge of the black matrix 202 thereunder. Therefore, the exposure on the photoresist layer 204 aligned to the partial transparent region 208b is between those of the color photoresist regions aligned to the transparent region 208a and the non-transparent region 208c.

In addition, in this embodiment the color photoresist layer 204 is a negative photoresist; therefore, the color photoresist pattern that should be left on the substrate 200 has enhanced bonding strength after exposure to a light source, lest the structure of the color photoresist pattern is destroyed by a subsequent development process. Of course, in other embodiments if a positive photoresist serves as the color photoresist layer, the arrangements of transparent region 208a, the partial transparent region 208b and the non-transparent region 208c of the photomask 206 will be opposite those of the embodiment.

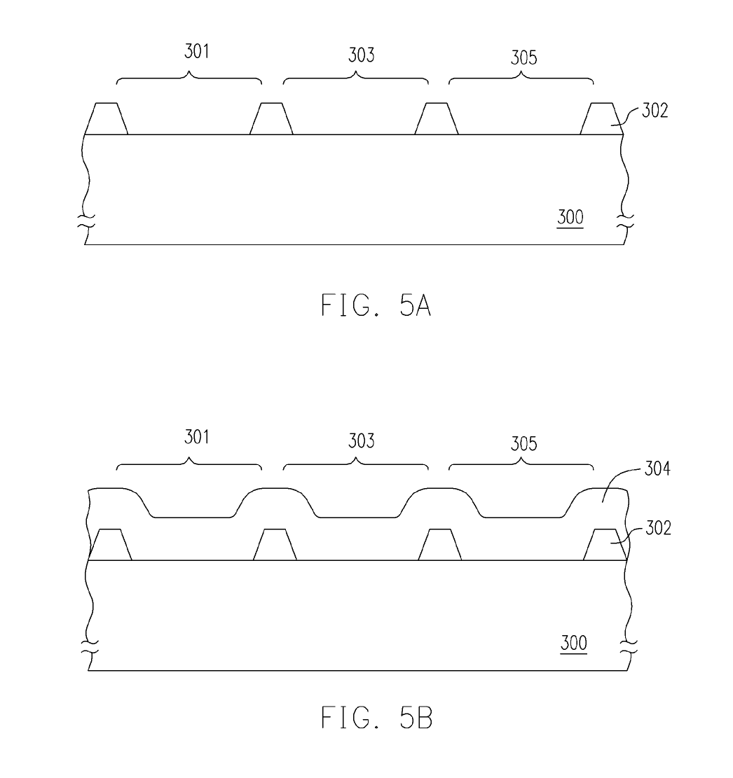

In addition, according to another preferred embodiment, a transparent ratio of the partial transparent region 208b of the photomask 206, for example, is gradually reduced from the transparent region 208a to the non-transparent region 208c as shown in FIG. 4. The exposure on the photoresist layer 204 aligned to the photomask 206 is gradually reduced from the regions aligned to the transparent region 208a to the regions aligned to the non-transparent region 208c.

Then, referring to FIG. 3D, a development process is performed for patterning the color photoresist layer 204 to form a patterned color photoresist layer 204a. In the prior process, the photomask 206 having a partial transparent region 208b is used during a development process 210 for the color photoresist layer 204. Therefore, during the subsequent development process, the color photoresist region 204 which is aligned to the partial transparent region 208b has a removal rate between the removal rates of the color photoresist layer 204 which are aligned to the transparent region 208a and the non-transparent region 208b. Accordingly, the step height issue at the interface of the black matrix 202 and color photoresist layer 204a, i.e. at the edge of the black matrix, can be resolved, and the color photoresist layer 204a has a planar surface.

Referring to FIG. 3D, following is a description of the structure of the color filter substrate of the present invention, comprising a substrate 200, a black matrix 202 and a color photoresist layer 204a. The black matrix 202 is formed on the substrate 200 and the material of the black matrix 202 is, for example, black resin.

In addition, the color photoresist layer 204a is formed on the substrate 200, a portion of the color photoresist layer 204a covers the edge of the black matrix 202, and the color photoresist layer 204a has a planar surface.

Of course, the application of the present invention is not limited to the fabrication of mono-color filter substrates; the present invention can also be applied to the fabrication of full-color filter substrates. Following are the detail descriptions for fabricating a full-color filter substrate.

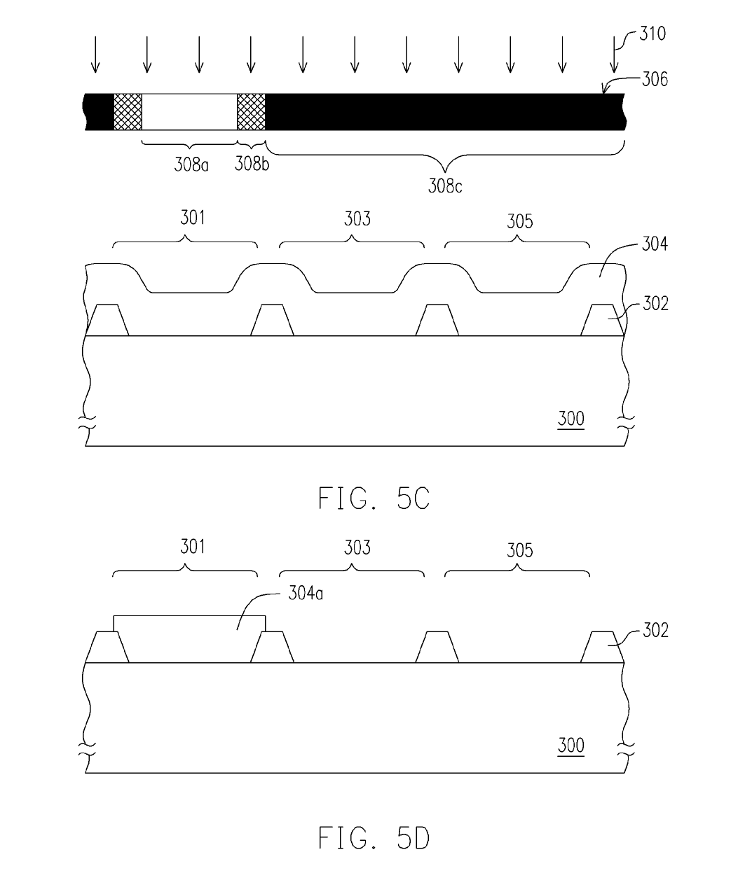

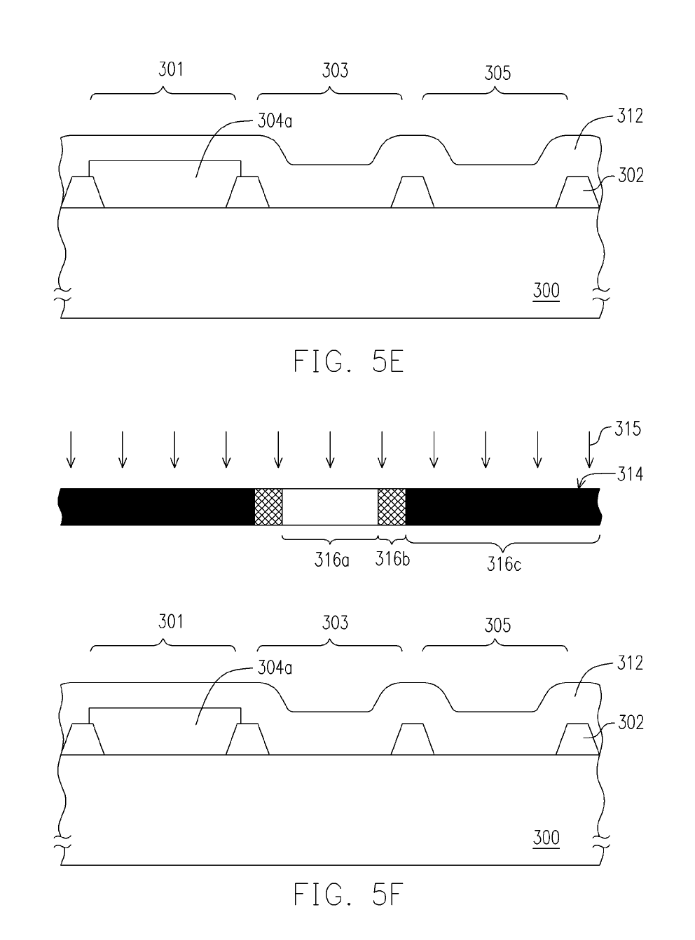

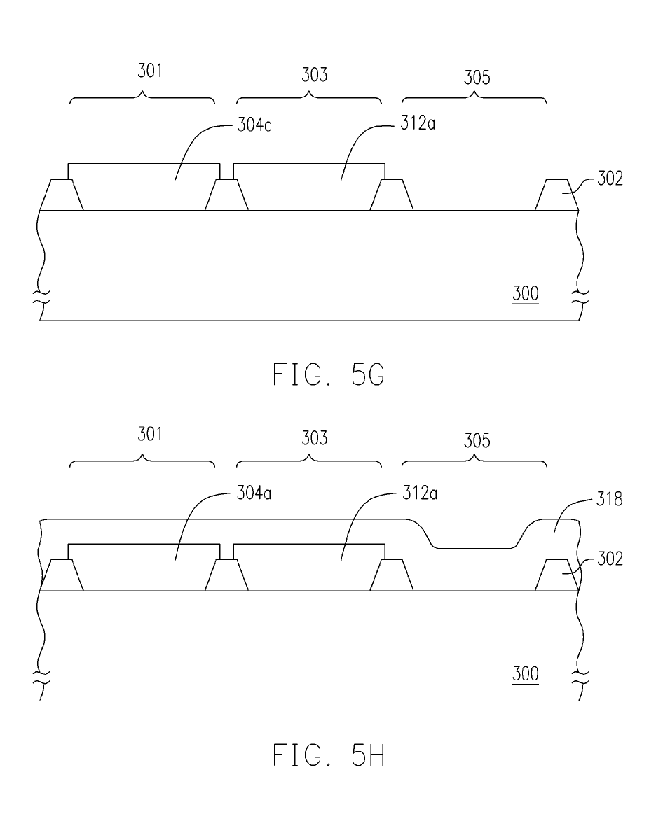

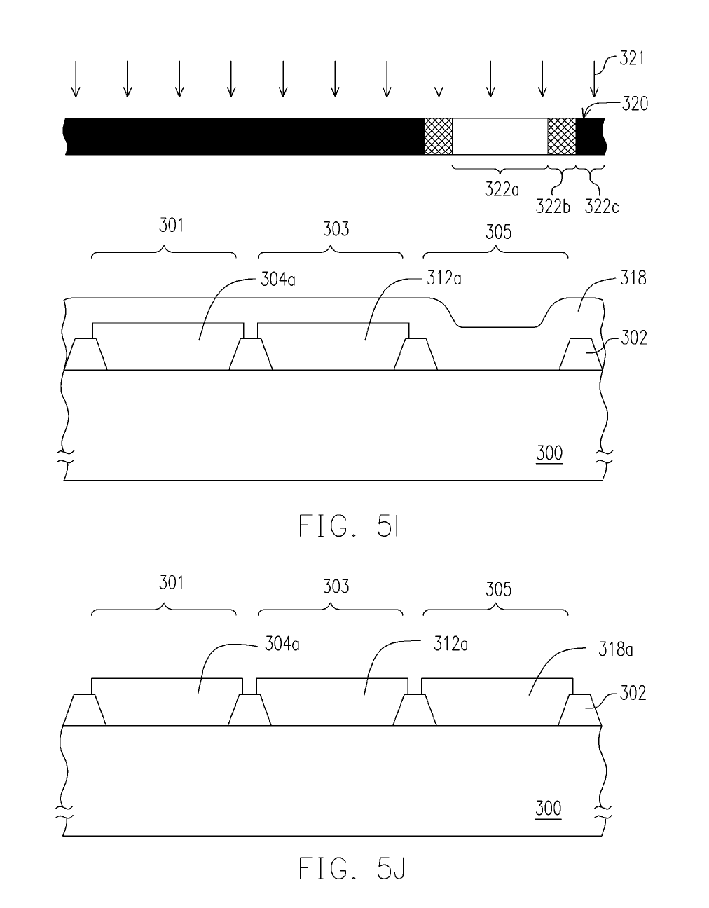

FIGS. 5A to 5J are schematic cross sectional views showing the progression process steps of a process of fabricating a full-color filter substrate according to preferred embodiment of the present invention.

Referring to FIG. 5A, the method of fabricating a full-color filter substrate begins with a comprehensive formation of a non-transparent material (not shown) on a substrate 300. The material of the non-transparent material is, for example, black resin having a thickness of about 1.0 μm to about 1.2 μm. A traditional photolithographic process is performed on the non-transparent material for patterning a black matrix 302, and the substrate 300 is divided into several sub-pixel regions by the black matrix 302. These sub-pixel regions includes a red sub-pixel region 301, a green sub-pixel region 303 and a blue sub-pixel region 305 according to the color of the color photoresist layer formed thereon.

Then, referring to FIG. 5B, a red color photoresist layer 304 is formed on the substrate 300 for covering the black matrix 302, wherein the red color photoresist layer 304 can be formed, for example, by a spin coating process and a baking process. In this embodiment, the red color photoresist layer 304 is a negative photoresist.

Then, referring to FIG. 5C, a photomask 306 is located over the substrate 300 for performing an exposure process 310 on the red color photoresist layer 304, wherein the photomask has a transparent region 308a, a partial transparent region 308b and a non-transparent region 308c, and wherein the partial transparent region 308b is located between the transparent region 308a and the non-transparent region 308c. In addition, in this embodiment the red color photoresist layer 304 is a negative photoresist, so the red color photoresist layer 304 that should be left is aligned to the transparent region 308a of the photomask 306. Then, a development process is performed for forming red color photoresist layer 304a at red sub-pixel region 301 as shown in FIG. 5D.

Then, referring to FIG. 5E, a green color photoresist layer 312 is formed on the substrate 300 covering the red color photoresist layer 304a and black matrix 302.

Referring to FIG. 5F, a photomask 314 is located over the substrate 300 for performing an exposure process 315 for the green color photoresist layer 314, wherein the photomask 314 has similar characteristics as the photomask 306, which includes a transparent region 316a, a partial transparent region 316b and a non-transparent region 316c, and the partial transparent region 316b is located between the transparent region 316a and the non-transparent region 316c. Moreover, the photomask 314 has a pattern based on the different circuit design requirements. Then another development process is performed for forming a green color photoresist layer 312a at the green sub-pixel region 303 as shown in FIG. 5G.

Then, referring to FIG. 5H, a blue color photoresist layer 318 is formed on the substrate 300 and covers the red color photoresist layer 304a, the green color photoresist layer 312a and black matrix 302.

Referring to FIG. 51, a photomask 320 is located over the substrate 300 for performing an exposure process 321 on the blue color photoresist layer 318, wherein the photomask 320 has similar characteristics as the photomask 306 or the photomask 314, which includes a transparent region 322a, a partial transparent region 322b and a non-transparent region 322c, and the photomask 320 has a pattern based on the different design requirements.

Then, referring to FIG. 5J, a development process is performed for forming blue color photoresist layer 318a at blue sub-pixel region 305. The arrangement of the red color photoresist layer 304a, the green color photoresist layer 312a and the blue color photoresist layer 318a can be, for example, mosaic, triangle, or tripe.

Of course, several films (not shown), such as a protection film, an electrode film and an alignment layer, are also sequentially formed on the color filter substrate which includes a mono-color or full-color filter substrate. The protection film is adapted to protect and planarize color photoresist layers, i.e. 204a, 304a, 312a and 318a. In addition, the material of the electrode film can be, for example, indium tin oxide (ITO) or the other material that can perform the same function. In addition, the alignment layer is adapted to arrange liquid crystal molecules formed thereon in a specific direction for pre-tilting the liquid crystal molecules. Another surface of the substrate 200 or 300 further comprises a polarizer for displaying.

From the descriptions mentioned above, because the present invention uses a mask having a partial transparent region for performing an exposure process, a photoresist region is formed after the exposure process is performed. The removal rate of the photoresist region formed by the partial transparent region is between those of the photoresist regions formed by a transparent region and by a non-transparent region. Therefore, the present invention can resolve the step height issue at an edge of a black matrix.

In addition, not only does the method of fabricating a color filter substrate in accordance with the present invention not create environmental pollution problems, but also the color photoresist layer formed thereon has a planar surface. Therefore, liquid crystal displays with the color filter substrates formed by the present invention does not have the displaying problems of liquid crystal displays formed by the prior arts.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention. Therefore, the scope of the present invention should be interpreted by the claims described below.

1. A method of fabricating a color filter substrate, the method comprising:
forming a black matrix on a substrate;
forming a color photoresist layer on the substrate covering the black matrix;
setting a photomask above the substrate and performing an exposure process over the photoresist layer, wherein the photomask has a transparent region, a partial transparent region and a non-transparent region, and the partial transparent region is located between the transparent region and the non-transparent region and aligned to the edge of the black matrix; and
performing a development process for patterning the color photoresist layer.

2. The method of fabricating a color filter substrate of claim 1, wherein the transparent area of the partial transparent region is gradually reduced from the transparent region to the non-transparent region.

3. The method of fabricating a color filter substrate of claim 1, wherein the material of the black matrix comprises black resin.

4. A method of fabricating a color filter substrate, the method comprising:
forming a black matrix on a substrate, the black matrix having a first region, a second region and a third region;
forming a first color photoresist layer on the substrate for covering the black matrix;
setting a first photomask above the substrate for performing a first exposure process for the first photoresist layer, wherein the first photomask has a first transparent region, a first partial transparent region and a first non-transparent region, and the first partial transparent region is located between the first transparent region and the first non-transparent region and aligned to the edge of the black matrix;
performing a first development process for patterning the first color photoresist layer to form a patterned first color photoresist layer in the first region;
forming a second color photoresist layer on the substrate and covering the patterned first photoresist layer and the black matrix;
setting a second photomask above the substrate for performing a second exposure process over the second photoresist layer, wherein the second photomask has a second transparent region, a second partial transparent region and a second non-transparent region, and the second partial transparent region is located between the second transparent region and the second non-transparent region and aligned to the edge of the black matrix;
performing a second development process for patterning the second color photoresist layer to form a patterned second color photoresist layer in the second region;
forming a third color photoresist layer on the substrate and covering the patterned first photoresist layer, the patterned second photoresist layer and the black matrix;
setting a third photomask above the substrate for performing a third exposure process for the third photoresist layer, wherein the third photomask has a third transparent region, a third partial transparent region and a third non-transparent region, and the third partial transparent region is located between the third transparent region and the third non-transparent region and aligned to the edge of the black matrix; and
performing a third development process for patterning the third color photoresist layer to form a patterned third color photoresist layer in the third region.

5. The method of fabricating a color filter substrate of claim 4, wherein the first transparent area of the first partial transparent region is gradually reduced from the first transparent region to the first non-transparent region.

6. The method of fabricating a color filter substrate of claim 4, wherein the second transparent area of the second partial transparent region is gradually reduced from the second transparent region to the second non-transparent region.

7. The method of fabricating a color filter substrate of claim 4, wherein the third transparent area of the third partial transparent region is gradually reduced from the third transparent region to the third non-transparent region.

8. The method of fabricating a color filter substrate of claim 4, wherein the material of the black matrix comprises black resin.

9. A structure of a color filter substrate, comprising:
a substrate;
a black matrix formed on the substrate; and
a color photoresist layer covering the substrate, wherein
a portion of the color photoresist layer covers the edge of the black matrix and wherein the surface of the color photoresist layer is planar.

10. The structure of a color filter substrate of claim 9, wherein the material of the black matrix comprises black resin.
